(19) United States
(12) Patent Application Publication
(10) Pub. No.: US 2025/0321537 A1
(43) Pub. Date: Oct. 16, 2025

(54) PHOTOPOLYMER COMPOSITION, HOLOGRAM RECORDING MEDIUM, PREPARATION METHOD THEREOF AND OPTICAL ELEMENT COMPRISING THE SAME

(71) Applicant: LG CHEM, LTD., Seoul (KR)

(72) Inventors: Min Soo KIM, Daejeon (KR); Hanna LEE, Daejeon (KR); Yeonhui YI, Daejeon (KR); Soonhwa JUNG, Daejeon (KR); Inkyu LEE, Daejeon (KR); Chulsuk HONG, Daejeon (KR)

(73) Assignee: LG CHEM, LTD., Seoul (KR)

(21) Appl. No.: 18/868,022

(22) PCT Filed: Oct. 11, 2023
(86) PCT No.: PCT/KR2023/015584

§ 371 Date: Nov. 21, 2024

(30) Foreign Application Priority Data
Nov. 4, 2022 (KR) 10-2022-0146071
Nov. 4, 2022 (KR) 10-2022-0146074

(51) Int. Cl. G03H 1/02; C08L 35/02

(52) U.S. Cl. CPC G03H 1/02; C08L 35/02; C08L 2312/00; G03H 2001/0264

(57) ABSTRACT

The present invention relates to a photopolymer composition, a hologram recording medium, a preparation method thereof, and an optical element comprising the same. The photopolymer composition includes an electron donor whose reaction energy with a photosensitizing dye excited into a triplet state is-25 to 0 KJ/mol, thereby being able to provide a hologram recording medium that not only is excellent in optical recording characteristics such as diffraction efficiency which are the basic physical properties of hologram recording media, but also exhibits excellent high-temperature stability over time before recording optical information, so that it can exhibit the originally intended optical recording characteristics even when stored at room temperature to high temperature for a long period of time, and can reproduce clear images without problems such as halo.

### CROSS-REFERENCE TO RELATED APPLICATION(S)

This application is a 35 U.S.C. § 371 National Phase Entry Application from PCT/KR2023/015584, filed on Oct. 11, 2023, which claims the benefit of Korean Patent Application No. 10-2022-0146071 filed on Nov. 4, 2022 and Korean Patent Application No. 10-2022-0146074 filed on Nov. 4, 2022 in the Korean Intellectual Property Office, the disclosures of which are incorporated herein by reference in their entirety.

The present invention relates to a photopolymer composition, a hologram recording medium, a preparation method thereof, and an optical element comprising the same.

### BACKGROUND

### Technical Field

Hologram recording medium records information by changing a refractive index in the holographic recording layer in the medium through an exposure process, reads the variation of refractive index in the medium thus recorded, and reproduces the information. In this regard, a photopolymer composition can be used for preparing a hologram.

The photopolymer can easily store light interference pattern as a hologram by photopolymerization of a photoreactive monomer. Therefore, the photopolymer can be used in various fields such as, for example, smart devices such as mobile devices, wearable display parts, vehicle articles (e.g., head up display), holographic fingerprint recognition system, optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

Specifically, a photopolymer composition for preparing a hologram includes a polymer matrix, a photoreactive monomer, and a photoinitiator system, and the photopolymer layer prepared from such a composition is irradiated with laser interference light to induce photopolymerization of local monomers.

A refractive index modulation is generated through this local photopolymerization process, and a diffraction grating is generated by such a refractive index modulation. The refractive index modulation value (An) is influenced by the thickness and the diffraction efficiency (DE) of the photopolymer layer, and the angular selectivity increases as the thickness decreases.

Recently, a request for development of materials capable of maintaining a stable hologram with a high diffraction efficiency has been increased, and also various attempts have been made to prepare a photopolymer layer having high diffraction efficiency and high refractive index modulation values as well as a thin thickness.

On the other hand, hologram recording media need to exhibit excellent stability over time even before recording optical information, and thus exhibit originally intended optical recording characteristics. However, the hologram recording media have a limitation of failing to exhibit originally intended optical recording characteristics as the photoinitiator system reacts during storage.

### DETAILED DESCRIPTION OF THE INVENTION

### Technical Problem

According to an embodiment of the present invention, a photopolymer composition is provided.

According to another embodiment of the present invention, a hologram recording medium is provided.

According to yet another embodiment of the present invention, a method for preparing the hologram recording medium is provided.

According to a further embodiment of the present invention, an optical element comprising the hologram recording medium is provided.

### Technical Solution

Now, a photopolymer composition, a hologram recording medium, a preparation method thereof, an optical element comprising the same, and the like according to specific embodiments of the present invention will be described.

The term “hologram recording medium” as used herein means a medium (or media) on which optical information can be recorded in an entire visible range and an ultraviolet range (e.g., 300 to 1,200 nm) through an exposure process, unless specifically stated otherwise. Therefore, the hologram recording medium herein may mean a medium on which optical information is recorded, or may mean a medium before recording that is capable of recording optical information. The hologram herein may include all of visual holograms such as in-line (Gabor) holograms, off-axis holograms, full-aperture transfer holograms, white light transmission holograms (“rainbow holograms”), Denisyuk holograms, off-axis reflection holograms, edge-lit holograms or holographic stereograms.

According to one embodiment of the invention, there is provided a photopolymer composition comprising: a polymer matrix formed by crosslinking a siloxane-based polymer containing a silane functional group and a (meth)acrylic-based polyol or a precursor thereof; a photoreactive monomer; and a photoinitiator system containing a photosensitizing dye and a coinitiator, wherein the coinitiator includes an electron donor whose reaction energy with a photosensitizing dye excited into a triplet state is-25 to 0 KJ/mol.

The present inventors have found through experiments that when a photosensitizing dye and an electron donor showing a specific reaction energy are used in combination as a photoinitiator system of a photopolymer composition to form a hologram recording medium, it is possible to provide a hologram recording medium that not only is excellent in optical recording characteristics but also exhibits excellent stability over time at room temperature to high temperature, and can reproduce clear images without problems such as halo, and completed the present invention.

A photopolymer composition, a hologram recording medium formed from the photopolymer composition, a preparation method thereof, an optical element comprising the hologram recording medium, and the like according to one embodiment of the present invention will be described below.

The photopolymer composition according to one embodiment of the invention includes a polymer matrix or a precursor thereof that serves as a support for the photopolymer layer formed therefrom.

The polymer matrix is formed by crosslinking a siloxane-based polymer containing a silane functional group (Si—H) and a (meth)acrylic-based polyol. Specifically, the polymer matrix is formed by crosslinking (meth)acrylic-based polyol with a siloxane-based polymer containing a silane functional group. More specifically, the hydroxy group of the (meth)acrylic-based polyol can form a crosslink with the silane functional group of the siloxane-based polymer through a hydrosilylation reaction. The hydrosilylation reaction can proceed rapidly under a Pt-based catalyst even at relatively low temperature (e.g., a temperature around 60° C.). Therefore, the photopolymer composition employs a polymer matrix that can be quickly crosslinked even at relatively low temperature as a support, thereby being able to improve the preparation efficiency and productivity of the hologram recording medium.

The polymer matrix can enhance the mobility of components (e.g., photoreactive monomer or plasticizer, etc.) contained in the photopolymer composition due to the flexible main chain of the siloxane-based polymer. In addition, siloxane bonding having excellent heat resistance and moist heat resistance characteristics can facilitate ensuring reliability of the photopolymer layer recorded with optical information, and of the hologram recording medium including the same.

The polymer matrix may have a relatively low refractive index, which can serve to enhance the refractive index modulation of the photopolymer layer. For example, the upper limit of the refractive index of the polymer matrix may be 1.53 or less, 1.52 or less, 1.51 or less, 1.50 or less, or 1.49 or less. And, the lower limit of the refractive index of the polymer matrix may be, for example, 1.40 or more, 1.41 or more, 1.42 or more, 1.43 or more, 1.44 or more, 1.45 or more, or 1.46 or more. As used herein, “refractive index” may be a value measured with an Abbe refractometer at 25° C.

The photopolymer composition includes a polymer matrix formed by crosslinking the siloxane-based polymer containing a silane functional group and the (meth)acrylic-based polyol, but may include a precursor of the polymer matrix that is not crosslinked. At this time, the precursor of the polymer matrix may mean a siloxane-based polymer, (meth)acrylic-based polyol, and Pt-based catalyst.

The siloxane-based polymer may include, for example, a repeating unit represented by the following Chemical Formula 1 and a terminal end group represented by the following Chemical Formula 2.

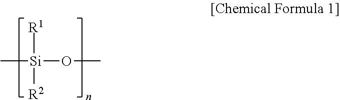

wherein, in Chemical Formula 1,
a plurality of R¹ and R² are the same or different from each other, and are each independently hydrogen, halogen, or an alkyl group having 1 to 10 carbon atoms, and
n is an integer of 1 to 10,000,

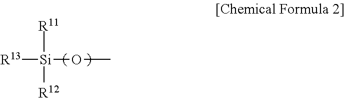

wherein, in Chemical Formula 2,
a plurality of R¹¹ to R¹³ are the same or different from each other, and are each independently hydrogen, halogen, or an alkyl group having 1 to 10 carbon atoms, and
at least one of R¹, R² and R¹¹ to R¹³ of at least one repeating unit selected among the repeating units represented by Chemical Formula 1 and any one terminal end group selected among the terminal end groups represented by Chemical Formula 2 is hydrogen.

In Chemical Formula 2,-(O)-means either bonding through oxygen (O) or directly bonding without oxygen (O) when Si of the terminal end group represented by Chemical Formula 2 is bonded to the repeating unit represented by Chemical Formula 1.

As used herein, “alkyl group” may be a straight chain, branched chain, or cyclic alkyl group. By way of non-limiting example, “alkyl group” as used herein may be methyl, ethyl, propyl (e.g. n-propyl, isopropyl, etc.), butyl (e.g., n-butyl, isobutyl, tert-butyl, sec-butyl, cyclobutyl, etc.), pentyl (e.g., n-pentyl, isopentyl, neopentyl, tert-pentyl, 1,1-dimethyl-propyl, 1-ethyl-propyl, 1-methyl-butyl, cyclopentyl, etc.), hexyl (e.g., n-hexyl, 1-methylpentyl, 2-methylpentyl, 4-methylpentyl, 3,3-dimethylbutyl, 1-ethyl-butyl, 2-ethylbutyl, cyclopentylmethyl, cyclohexyl, etc.), heptyl (e.g., n-heptyl, 1-methylhexyl, 4-methylhexyl, 5-methylhexyl, cyclohexylmethyl, etc.), octyl (e.g., n-octyl, tert-octyl, 1-methylheptyl, 2-ethylhexyl, 2-propylpentyl, etc.), nonyl (e.g., n-nonyl, 2,2-dimethylheptyl, etc.), and the like.

In one example, R¹, R² and R¹¹ to R¹³ in Chemical Formulas 1 and 2 are methyl or hydrogen, and at least two of R¹, R² and R¹¹ to R¹³ may be hydrogen. More specifically, the siloxane-based polymer may be a compound in which R¹ and R² of Chemical Formula 1 are each independently methyl and hydrogen, and R¹¹ to R¹³ of Chemical Formula 2 are each independently methyl or hydrogen (e.g., polymethylhydrosiloxane whose terminal end group is a trimethylsilyl group or a dimethylhydrosilyl group); a compound in which some R¹ and R² of Chemical Formula 1 are methyl and hydrogen, respectively, both the remaining R¹ and R² are methyl, and R¹¹ to R¹³ of Chemical Formula 2 are each independently methyl or hydrogen (e.g., poly (dimethylsiloxane-co-methylhydrosiloxane) whose terminal end group is a trimethylsilyl group or a dimethylhydrosilyl group); or a compound in which both R¹ and R² of Chemical Formula 1 are methyl, at least one of R¹¹ to R¹³ of Chemical Formula 2 is hydrogen, and the remainder are each independently methyl or hydrogen (e.g., polydimethylsiloxane in which either or both of the terminal end groups are dimethylhydrosilyl groups).

The siloxane-based polymer may have a number average molecular weight (Mn) in the range of 200 to 4,000 as an example. Specifically, the lower limit of the number average molecular weight of the siloxane-based polymer may be, for example, 200 or more, 250 or more, 300 or more, or 350 or more, and the upper limit thereof may be, for example, 3,500 or less, 3,000 or less, 2,500 or less, 2,000 or less, 1,500 or less, or 1,000 or less. When the number average molecular weight of the siloxane-based polymer satisfies the above range, it is possible to prevent the problems that during the crosslinking process with (meth)acrylic-based polyol which is performed at room temperature or higher, the siloxane-based polymer volatilizes and the degree of matrix crosslinking decreases, or the siloxane-based polymer has poor compatibility with other components of the photopolymer composition and thus, phase separation occurs between the components, thereby allowing the hologram recording medium to exhibit excellent optical recording characteristics and heat stability.

The number average molecular weight means a number average molecular weight (unit: g/mol) in terms of polystyrene determined by GPC method. In the process of determining the number average molecular weight in terms of polystyrene measured by the GPC method, a commonly known analyzing device, a detector such as a refractive index detector, and an analytical column can be used, and commonly applied conditions for temperature, solvent, and flow rate can be used. Specific examples of the measurement conditions may include a temperature of 30° C., tetrahydrofuran solvent and a flow rate of 1 mL/min.

The silane functional group (Si—H) equivalent of the siloxane-based polymer may be, for example, in the range of 30 to 200 g/equivalent. More specifically, the silane functional group (Si—H) equivalent of the siloxane-based polymer may be 50 g/equivalent or more, 60 g/equivalent or more, 70 g/equivalent or more, 80 g/equivalent or more, or 90 g/equivalent or more, and 180 g/equivalent or less, or 150 g/equivalent or less.

As used herein, “equivalent of a certain functional group” briefly refers to the number of gram equivalents (also called equivalent weight) expressed in units of g/equivalent, and means the value obtained by dividing the molecular weight (weight average molecular weight, number average molecular weight, etc.) of a molecule or polymer containing the functional group by the number of the functional group. Therefore, as the equivalent value is smaller, the density of the functional group is higher, and as the equivalent value is larger, the density of the functional group is smaller.

When the silane functional group equivalent of the siloxane-based polymer satisfies the above range, the polymer matrix has an appropriate crosslinking density and thus, sufficiently performs the role of a support, and the mobility of the components included in the photopolymer composition is improved, which allows the initial refractive index modulation value to be maintained at an excellent level even as time passes without the problem of collapsing the boundary surfaces of the diffraction gratings generated after recording, thereby minimizing the decrease in recording properties for optical information.

The (meth)acrylic-based polyol may mean a polymer in which one or more, specifically two or more, hydroxy groups are bonded to the main chain or side chain of a (meth)acrylate-based polymer. Unless specifically stated otherwise, “(meth)acrylic (based)” as used herein refers to acrylic (based) and/or methacrylic (based), which is a term that encompasses all of acrylic (based), methacrylic (based), or a mixture of acrylic (based) and methacrylic (based).

The (meth)acrylic-based polyol is a homopolymer of a (meth)acrylate-based monomer having a hydroxy group, a copolymer of two or more types of (meth)acrylate-based monomers having a hydroxy group, or a copolymer of a (meth)acrylate-based monomer having a hydroxy group and a (meth)acrylate-based monomer having no hydroxy group. As used herein. “copolymer” is a term that encompasses all of a random copolymer, a block copolymer and a graft copolymer, unless otherwise specified.

The (meth)acrylate-based monomer having a hydroxy group may include, for example, hydroxyalkyl (meth)acrylate, hydroxyaryl (meth)acrylate, or the like, the alkyl is an alkyl having 1 to 30 carbon atoms, and the aryl may be an aryl having 6 to 30 carbon atoms. Further, the (meth)acrylate-based monomer having no hydroxy group may include, for example, an alkyl (meth)acrylate-based monomer, an aryl (meth)acrylate-based monomer, or the like, the alkyl may be an alkyl having 1 to 30 carbon atoms, and the aryl may be an aryl having 6 to 30 carbon atoms.

The (meth)acrylic-based polyol may have a weight average molecular weight (Mw) in the range of 150,000 to 1,000,000 as an example. The weight average molecular weight means a weight average molecular weight in terms of polystyrene measured by the GPC method as described above. For example, the lower limit of the weight average molecular weight may be 150,000 or more, 200,000 or more, or 250,000 or more, and the upper limit thereof may be, for example, 900,000 or less, 850,000 or less, 800,000 or less, 750,000 or less, 700,000 or less, 650,000 or less, 600,000 or less, 550,000 or less, 500,000 or less, or 450,000 or less. When the weight average molecular weight of the (meth)acrylic-based polyol satisfies the above range, the polymer matrix sufficiently exerts the function as a support and thus, the recording properties for optical information less decrease even after the usage time has passed, and sufficient flexibility is imparted to the polymer matrix, thereby being able to improve the mobility of components (e.g., photoreactive monomer or plasticizer, etc.) contained in the photopolymer composition, and minimize the decrease in recording properties for optical information.

In order to adjust the crosslinking density of the (meth)acrylic-based polyol by the siloxane-based polymer at a level that is advantageous for ensuring the function of the hologram recording medium, the hydroxy equivalent of the (meth)acrylic-based polyol may be adjusted to an appropriate level.

Specifically, the hydroxy (—OH) equivalent of the (meth)acrylic-based polyol may be, for example, in the range of 500 to 3,000 g/equivalent. More specifically, the lower limit of the hydroxy group (—OH) equivalent of the (meth)acrylic-based polyol may be 600 g/equivalent or more, 700 g/equivalent or more, 800 g/equivalent or more, 900 g/equivalent or more, 1000 g/equivalent or more, 1100 g/equivalent or more, 1200 g/equivalent or more, 1300 g/equivalent or more, 1400 g/equivalent or more, 1500 g/equivalent or more, 1600 g/equivalent or more, 1700 g/equivalent or more, or 1750 g/equivalent or more. And, the upper limit of the hydroxy group (—OH) equivalent of the (meth)acrylic-based polyol may be 2900 g/equivalent or less, 2800 g/equivalent or less, 2700 g/equivalent or less, 2600 g/equivalent or less, 2500 g/equivalent or less, 2400 g/equivalent or less, 2300 g/equivalent or less, 2200 g/equivalent or less, 2100 g/equivalent or less, 2000 g/equivalent or less, or 1900 g/equivalent or less.

When the hydroxy (—OH) equivalent of the (meth)acrylic-based polyol satisfies the above range, the polymer matrix has an appropriate crosslinking density and thus, sufficiently performs the role of a support, and the mobility of the components included in the photopolymer composition is improved, which allows the initial refractive index modulation value to be maintained at an excellent level even as time passes without the problem of collapsing the boundary surfaces of the diffraction gratings generated after recording, thereby minimizing the decrease in recording properties for optical information.

For example, the (meth)acrylic-based polyol may have a glass transition temperature (Tg) in the range of-60 to ˜10° C. Specifically, the lower limit of the glass transition temperature may be, for example, −55° C. or more, −50° C. or more, −45° C. or more, −40° C. or more, −35° C. or more, −30° C. or more, or −25° C. or more, and the upper limit thereof may be, for example, −15° C. or less, −20° C. or less, −25° C. or less, −30° C. or less, or −35° C. or less. If the above glass transition temperature range is satisfied, it is possible to lower the glass transition temperature without significantly reducing the modulus of the polymer matrix, thereby increasing the mobility (fluidity) of other components in the photopolymer composition, and also improving the moldability of the photopolymer composition. The glass transition temperature can be measured using a known method, for example, DSC (Differential Scanning calorimetry) or DMA (dynamic mechanical analysis).

The refractive index of the (meth)acrylic-based polyol may be, for example, 1.40 or more and less than 1.50. Specifically, the lower limit of the refractive index of the (meth)acrylic-based polyol may be, for example, 1.41 or more, 1.42 or more, 1.43 or more, 1.44 or more, 1.45 or more, or 1.46 or more, and the upper limit thereof may be, for example, 1.49 or less, 1.48 or less, 1.47 or less, 1.46 or less, or 1.45 or less. When the (meth)acrylic-based polyol has a refractive index within the above-mentioned range, it can contribute to increasing the refractive index modulation. The refractive index of the (meth)acrylic-based polyol is a theoretical refractive index, and can be calculated using the refractive index (value measured using an Abbe refractometer at 25° C.) of the monomer used for preparing the (meth)acrylic-based polyol and the fraction (molar ratio) of each monomer. The (meth)acrylic-based polyol and the siloxane-based polymer can be included so that the molar ratio (SiH/OH) of the silane functional group (Si—H) of the siloxane-based polymer to the hydroxy group (—OH) of the (meth)acrylic-based polyol is 1.5 to 4.

The molar ratio of the silane functional group of the siloxane-based polymer to the hydroxy group of the (meth)acrylic-based polyol (hereinafter simply referred to as SiH/OH molar ratio) can be calculated from the number of moles of functional groups confirmed from the weight of each polymer and the corresponding functional group equivalent of each polymer.

Specifically, the silane functional group equivalent of the siloxane-based polymer is the value obtained by dividing the molecular weight (e.g., number average molecular weight) of the siloxane-based polymer by the number of silane functional groups per molecule, and the hydroxy equivalent of the (meth)acrylic-based polyol is the value obtained by dividing the molecular weight (e.g., weight average molecular weight) of the (meth)acrylic-based polyol by the number of hydroxy functional groups per molecule. Therefore, if the weight of the siloxane-based polymer is divided by the silane functional group equivalent of the siloxane-based polymer, the number of moles of the silane functional group can be confirmed, and if the weight of the (meth)acrylic-based polyol is divided by the hydroxy equivalent of the (meth)acrylic-based polyol, the number of moles of a hydroxy group can be confirmed. More specifically, looking at Example 1 described below, if the weight (2.6 g) of the siloxane-based polymer used in Example 1 is divided by the silane functional group equivalent (103 g/equivalent) of the siloxane-based polymer used in Example 1, the number of moles (0.0252 mol) of a silane functional group is calculated, and if the weight (22.4 g) of the (meth)acrylic-based polyol used in Example 1 is divided by the hydroxy equivalent (1802 g/equivalent) of the (meth)acrylic-based polyol used in Example 1, the number of moles (0.0124 mol) of a hydroxy group is calculated. If the number of moles (0.0252 mol) of silane functional group is divided by the number of moles (0.0124 mol) of a hydroxy group, it is confirmed that the SiH/OH molar ratio is calculated as 2.

The lower limit of the SiH/OH molar ratio may be, for example, 1.6 or more, 1.7 or more, 1.8 or more, 1.9 or more, or 2.0 or more, and the upper limit thereof can be, for example, 3.9 or less, 3.8 or less, 3.7 or less, 3.6 or less, or 3.5 or less. When the SiH/OH molar ratio range is satisfied, the polymer matrix is crosslinked at an appropriate crosslinking density to improve the mobility of recording components (e.g., photoreactive monomers and plasticizers, etc.) and ensure excellent optical recording characteristics, and even if the photopolymer layer is placed in a high temperature and/or high humidity environment before and after recording, it can suppress migration or deformation of the components within the photopolymer layer and moisture penetration into the photopolymer layer, thereby exhibiting excellent heat resistance, moist heat resistance or the like.

The Pt-based catalyst may be, for example, Karstedt's catalyst, and the like. The Pt-based catalyst may be contained in an amount of 0.01 to 2 parts by weight based on 100 parts by weight of the (meth)acrylic-based polyol. Specifically, the Pt-based catalyst may be contained, for example, in an amount of 0.02 parts by weight or more, 0.03 parts by weight or more, 0.04 parts by weight or more, 0.05 parts by weight or more, or 0.06 parts by weight or more, and 1.5 parts by weight or less, 1.0 parts by weight or less, 0.5 parts by weight or less, 0.3 parts by weight or less, 0.2 parts by weight or less, 0.15 parts by weight or less, 0.14 parts by weight or less, 0.13 parts by weight or less, or 0.12 parts by weight or less, based on 100 parts by weight of the (meth)acrylic-based polyol. When the Pt-based catalyst is used in the above-mentioned amount, the polymer matrix can be crosslinked at an appropriate crosslinking density to exhibit desired optical recording characteristics.

The precursor of the polymer matrix may optionally further include rhodium-based catalysts, iridium-based catalysts, rhenium-based catalysts, molybdenum-based catalysts, iron-based catalysts, nickel-based catalysts, alkali metal or alkaline earth metal-based catalysts, Lewis acids-based or carbene-based non-metallic catalysts, in addition to the Pt-based catalyst.

On the other hand, a hologram recording medium according to one embodiment of the invention can be prepared by irradiating an object light and a reference light onto the photopolymer layer formed from the photopolymer composition. Due to the interference field between the object light and the reference light, photopolymerization of the photoreactive monomer does not occur in the destructive interference region, but photopolymerization of the photoreactive monomer occurs in the constructive interference region. As the photoreactive monomer is continuously consumed in the constructive interference region, a concentration difference occurs between the photoreactive monomer in the destructive interference region and the constructive interference region, and as a result, the photoreactive monomer in the destructive interference region diffuses into the constructive interference region. A diffraction grating is generated by the refractive index modulation thus generated.

Therefore, the photoreactive monomer may include a compound having a higher refractive index than the polymer matrix in order to realize the above-described refractive index modulation. However, all photoreactive monomers are not limited to those having a higher refractive index than the polymer matrix, and at least a part of the photoreactive monomers may have a higher refractive index than the polymer matrix, so as to realize a high refractive index modulation value. In one example, the photoreactive monomer may include a monomer having a refractive index of 1.50 or more, 1.51 or more, 1.52 or more, 1.53 or more, 1.54 or more, 1.55 or more, 1.56 or more, 1.57 or more, 1.58 or more, 1.59 or more, or 1.60 or more, and 1.70 or less.

The photoreactive monomer may include at least one monomer selected from the group consisting of a monofunctional monomer having one photoreactive functional group and a polyfunctional monomer having two or more photoreactive functional groups. Wherein, the photoreactive functional group may be, for example, a (meth)acryloyl group, a vinyl group, a thiol group, or the like. More specifically, the photoreactive functional group may be a (meth)acryloyl group.

The monofunctional monomer may include, for example, at least one selected from the group consisting of benzyl (meth)acrylate (M1182 having a refractive index of 1.5140, Miwon Specialty Chemical), benzyl 2-phenylacrylate, phenoxybenzyl (meth)acrylate (M1122 having a refractive index of 1.565, Miwon Specialty Chemical), phenol (ethylene oxide) (meth)acrylate (phenol (EO) (meth)acrylate; M140 having a refractive index of 1.516, Miwon Specialty Chemical), phenol (ethylene oxide) 2 (meth)acrylate (phenol (EO) 2 (meth)acrylate; M142 having a refractive index of 1.510, Miwon Specialty Chemical), O-phenylphenol (ethylene oxide) (meth)acrylate (O-phenylphenol (EO) (meth)acrylate; M1142 having a refractive index of 1.577, Miwon Specialty Chemical), phenylthioethyl (meth)acrylate (M1162 having a refractive index of 1.560, Miwon Specialty Chemical) and biphenylmethyl (meth)acrylate.

The polyfunctional monomer may include, for example, at least one selected from the group consisting of bisphenol A (ethylene oxide)₂₋₁₀ di(meth)acrylate (bisphenol A (EO) 2˜10 (meth)acrylate; M240 having a refractive index of 1.537, M241 having a refractive index of 1.529, M244 having a refractive index of 1.545, M245 having a refractive index of 1.537, M249 having a refractive index of 1.542, M2100 having a refractive index of 1.516, M2101 having a refractive index of 1.512, Miwon Specialty Chemical), bisphenol A epoxy di(meth)acrylate (PE210 having a refractive index of 1.557, PE2120A having a refractive index of 1.533, PE2120B having a refractive index of 1.534, PE2020C having a refractive index of 1.539, PE2120S having a refractive index of 1.556, Miwon Specialty Chemical), bisfluorene di(meth)acrylate (HR6022 having a refractive index of 1.600, HR6040 having a refractive index of 1.600, HR6042 having a refractive index of 1.600, Miwon Specialty Chemical), modified bisphenol fluorene di(meth)acrylate (HR 6060 having a refractive index of 1.584, HR6100 having a refractive index of 1.562, HR6200 having a refractive index of 1.530, Miwon Specialty Chemical), tris(2-hydroxyethyl) isocyanurate tri(meth)acrylate (M370 having a refractive index of 1.508, Miwon Specialty Chemical), phenol novolac epoxy (meth)acrylate (SC6300 having a refractive index of 1.525, Miwon Specialty Chemical) and cresol novolac epoxy (meth)acrylate (SC6400 having a refractive index of 1.522, SC6400C having a refractive index of 1.522, Miwon Specialty Chemical).

The photopolymer composition according to one embodiment of the invention may contain a photoreactive monomer in an amount of 50 to 300 parts by weight based on 100 parts by weight of the polymer matrix. For example, the lower limit of the content of the photoreactive monomer may be 50 parts by weight or more, 70 parts by weight or more, 100 parts by weight or more, or 120 parts by weight or more, and the upper limit thereof may be 300 parts by weight or less, 270 parts by weight or less, 250 parts by weight or less, or 220 parts by weight or less. When the above range is satisfied, it is advantageous for ensuring excellent optical recording characteristics.

The content of the polymer matrix herein means the total content (weight) of the (meth)acrylic-based polyol and siloxane-based polymer forming the matrix. In other words, the content of the polymer matrix means including both the content of the polymer matrix formed by crosslinking (meth)acrylic-based polyol and siloxane-based polymer and the content of the polymer matrix precursor that is not partially crosslinked.

The photopolymer composition may further include a plasticizer. When a plasticizer is added to the photopolymer composition, refractive index modulation can be more easily realized upon recording a hologram. More specifically, the plasticizer lowers the glass transition temperature of the polymer matrix, improves the mobility of the photoreactive monomer, and has a low refractive index and non-reactive properties. Thus, when a photoreactive monomer that is uniformly distributed within the polymeric matrix but is not photopolymerized moves, it can move in the direction opposite thereto and contribute to the refractive index modulation. Further, the plasticizer can also contribute to improving the moldability of photopolymer compositions.

The photopolymer composition may include a fluorinated compound as a plasticizer.

The fluorinated compound may have a low refractive index of 1.45 or less in order to perform the above-mentioned plasticizer function. Specifically, the upper limit of the refractive index may be, for example, 1.44 or less, 1.43 or less, 1.42 or less, 1.41 or less, 1.40 or less, 1.39 or less, 1.38 or less, or 1.37 or less, and the lower limit of the refractive index may be, for example, 1.30 or more, 1.31 or more, 1.32 or more, 1.33 or more, 1.34 or more, or 1.35 or more. Since a fluorinated compound having a lower refractive index than the above-mentioned photoreactive monomer is used, the refractive index of the polymer matrix can be further lowered, and the refractive index modulation with the photoreactive monomer can be made larger.

The fluorinated compound may include, for example, at least one functional group selected from the group consisting of an ether group, an ester group and an amide group, and two or more difluoromethylene groups. More specifically, the fluorinated compound may be, for example, a compound containing a repeating unit represented by the following Chemica Formula 3.

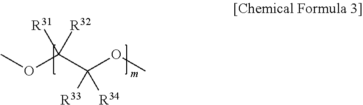

wherein, in Chemical Formula 3,
a plurality of R³¹ to R³⁴ are each independently hydrogen or fluorine, with the proviso that at least one of R³¹ to R³⁴ is fluorine, and m is an integer of 2 to 12.

More specifically, the fluorinated compound may be a compound containing 1 to 3 units represented by the following Chemical Formula 3-1.

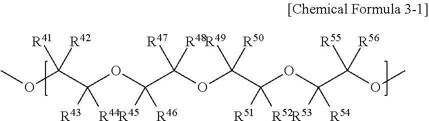

wherein, in Chemical Formula 3-1,
R⁴¹ to R⁴⁴ and R⁵³ to R⁵⁶ are each independently hydrogen or fluorine, and R⁴⁵ to R⁵² are fluorine.

In one example, in Chemical Formula 3-1, R⁴¹, R⁴², R⁵⁵, and R⁵⁶ are hydrogen, and R⁴³ to R⁵⁴ are fluorine.

The fluorinated compound containing (repeating) units represented by Chemical Formulas 3 and 3-1 are not particularly limited, but can be capped with an end capping agent widely used in the related technical field. In one example, the terminal end of the fluorinated compound containing the (repeating) unit represented by Chemical Formulas 3 and 3-1 may be an alkyl group or an alkyl group substituted with at least one alkoxy. By way of non-limiting example, 2-methoxyethoxymethyl chloride is used as an end capping agent and thus, the terminal end of the fluorinated compound containing the (repeating) unit represented by Chemical Formulas 3 and 3-1 may be a 2-methoxyethoxymethyl group.

The fluorinated compound may have a weight average molecular weight of 300 or more. Specifically, the lower limit of the weight average molecular weight of the fluorinated compound may be, for example, 350 or more, 400 or more, 450 or more, 500 or more, or 550 or more, and the upper limit thereof may be, for example, 1000 or less, 900 or less, 800 or less, 700 or less, or 600 or less. Considering refractive index modulation, compatibility with other components, elution problems of fluorinated compounds, and the like, it is preferable that the above weight average molecular weight range is satisfied. At this time, the weight average molecular weight means the weight average molecular weight in terms of polystyrene measured by the GPC method as described above.

The photopolymer composition of one embodiment may include 20 to 200 parts by weight of the fluorinated compound based on 100 parts by weight of the polymer matrix. Specifically, the lower limit of the content of the fluorinated compound may be, for example, 25 parts by weight or more, 30 parts by weight or more, 40 parts by weight or more, 50 parts by weight or more, 60 parts by weight or more, 70 parts by weight or more, or 80 parts by weight or more, and the upper limit thereof may be, for example, 190 parts by weight or less, 180 parts by weight or less, 170 parts by weight or less, 160 parts by weight or less, or 150 parts by weight or less. When the above range is satisfied, it can represent large refractive index modulation values after recording due to fluorinated compounds having sufficient low refractive index, without problems of deteriorating the compatibility with the components contained in the photopolymer composition, of eluting some fluorinated compounds to the surface of the photopolymer layer, or of degrading haze, which are thus advantageous for ensuring excellent optical recording characteristics.

On the other hand, when the element ratio measured on the surface of the photopolymer layer formed from a photopolymer composition containing a fluorinated compound satisfies a specific ratio, it not only has excellent optical recording characteristics but also can exhibit excellent stability over time even at high temperatures.

Specifically, the element ratio on the surface of the photopolymer layer can be confirmed by photoelectron spectroscopy called X-ray Photoelectron Spectroscopy (XPS) or Electron Spectroscopy for Chemical Analysis (ESCA). According to the photoelectron spectroscopy method described in Test Example described later, the elements found on the surface of the sample to be analyzed can be qualitatively analyzed through a survey scan, and then a narrow scan can be performed for each found element to determine the element ratio. The element ratio of the photopolymer layer herein may be understood as the element ratio of the photopolymer layer before recording or the element ratio of the photopolymer layer after recording. The element ratio of the photopolymer layer before recording and the element ratio of the photopolymer layer after recording may be the same within an experimental error range, but may be different from each other in some embodiments. That is, even if the element ratio before recording and the element ratio after recording of the photopolymer layer are different from each other beyond the error range, it is possible to exhibit the desired effect of the hologram recording medium prepared from the photopolymer composition of one embodiment as long as the element ratio before or after recording is within the above-mentioned range.

The carbon element ratio on the surface of the photopolymer layer formed from the photopolymer composition of one embodiment may be 50 atomic % or more, 51 atomic % or more, 52 atomic % or more, 53 atomic % or more, or 54 atomic % or more, and 70 atomic % or less, 69 atomic % or less, or 68 atomic % or less.

The nitrogen element ratio on the surface of the photopolymer layer may be 0.01 atomic % or more, 0.05 atomic % or more, 0.10 atomic % or more, or 0.20 atomic % or more, and 2 atomic % or less, 1.8 atomic % or less, 1.6 atomic % or less, 1.4 atomic % or less, or 1.2 atomic % or less.

The oxygen element ratio on the surface of the photopolymer layer may be 15 atomic % or more, 16 atomic % or more, or 17 atomic % or more, and 30 atomic % or less, 29 atomic % or less, 28 atomic % or less, 27 atomic % or less, or 26 atomic % or less.

The fluorine element ratio on the surface of the photopolymer layer may be 3 atomic % or more, or 4 atomic % or more, and 12 atomic % or less, 11 atomic % or less, or 10 atomic % or less.

The silicon element ratio on the surface of the photopolymer layer may be 3 atomic % or more, 4 atomic % or more, 4.5 atomic % or more, and 15 atomic % or less.

The ratio of carbon, nitrogen, oxygen, fluorine and silicon elements is a percentage (atomic %) of the total amount of carbon, nitrogen, oxygen, fluorine and silicon atoms on the surface of the photopolymer layer, which is confirmed by photoelectron spectroscopy.

As the photopolymer layer exhibits the above-mentioned element ratio, it can exhibit excellent optical recording characteristics and excellent stability over time at high temperatures. In particular, if the fluorine element ratio is less than the above range, the optical recording characteristics deteriorate, and if the fluorine element ratio exceeds the above range, there may be a problem that the layer is vulnerable to moisture and its stability over time decreases. Further, if the silicon element ratio is less than the above range, there may be a problem that the layer is vulnerable to heat and haze increases, and if the silicon element ratio exceeds the above range, there may be a problem that optical recording characteristics are significantly deteriorated.

Most of the components of the photopolymer layer can be said to be a polymer matrix, a photoreactive monomer, and a fluorinated compound which is a plasticizer added as necessary, wherein the polymeric matrix may also be included in the form of a precursor capable of forming the polymeric matrix. Therefore, the element ratio of the surface of the photopolymer layer can be controlled through the mixing ratio of the polymer matrix, photoreactive monomer, and fluorinated compound contained in the photopolymer composition. The photopolymer composition of one embodiment may contain 17 to 38% by weight of the polymer matrix, 36 to 58% by weight of the photoreactive monomer, and 17 to 38% by weight of the fluorinated compound, based on the total weight of the polymer matrix, photoreactive monomer, and fluorinated compound, in order to provide a photopolymer layer that satisfies the above-mentioned element ratio.

More specifically, the polymer matrix may be contained, for example, in an amount of 17% by weight or more, 18% by weight or more, 19% by weight or more, or 20% by weight or more, and 38% by weight or less, 37% by weight or less, or 36% by weight or less. The photoreactive monomer may be contained, for example, in an amount of 36% by weight or more, 37% by weight or more or 38% by weight or more, and 58% by weight or less, 55% by weight or less or 53% by weight or less. The fluorinated compound may be contained, for example, in an amount of 17% by weight or more, 18% by weight or more, 19% by weight or more, or 20% by weight or more, and 38% by weight or less, 35% by weight or less, 33% by weight or less, or 32% by weight or less. Within this range, it is possible to provide a photopolymer layer that satisfies the above-mentioned element ratio.

The photopolymer composition of one embodiment includes a photoinitiator system. The photoinitiator system may mean a photoinitiator that enables polymerization to initiate by light, or a combination of a photosensitizer and a coinitiator.

The photopolymer composition of one embodiment may include a photosensitizer and a coinitiator as a photoinitiator system. Further, the photosensitizer may be a photosensitizing dye.

Specifically, the photosensitizing dye may include, for example, at least one selected from the group consisting of a silicon rhodamine compound, a sulfonium derivative of ceramidonine, new methylene blue, thioerythrosine triethylammonium, 6-acetylamino-2-methylceramidonin, eosin, erythrosine, rose bengal, thionine, basic yellow, Pinacyanol chloride, rhodamine 6G, gallocyanine, ethyl violet, Victoria blue R, Celestine blue, Quinaldine Red, Crystal violet, Brilliant Green, Astrazon orange G, darrow red, pyronin Y, basic red 29, pyrylium I (pyrylium iodide), Safranin O, cyanine, methylene blue, Azure A, and BODIPY.

In one example, the photosensitizing dye may include a silicon rhodamine compound represented by the following Chemical Formula 4.

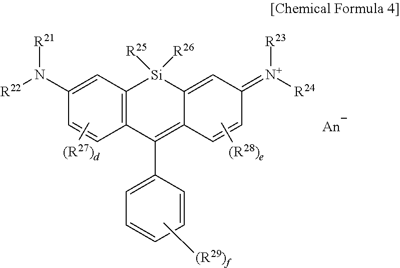

wherein, in Chemical Formula 4,
R²¹ to R²⁹ are each independently hydrogen, a substituted or unsubstituted alkyl group having 1 to 20 carbon atoms, a substituted or unsubstituted alkoxy group having 1 to 20 carbon atoms, a substituted or unsubstituted aryl group having 6 to 30 carbon atoms, or a substituted or unsubstituted aryloxy group having 6 to 30 carbon atoms,
d and e are each independently an integer of 0 to 3,
f is an integer of 0 to 5, and
An⁻ is an anion.

In the above, “substituted or unsubstituted” means that hydrogen or carbon is substituted with another element, wherein hydrogen may be substituted with a halogen, a hydroxy group, an alkyl group with 1 to 10 carbon atoms, or an alkoxy group with 1 to 10 carbon atoms, and carbon (—CH₂—) may be substituted with —O— or —CO—.

In Chemical Formula 4, R²¹ to R²⁸ may be each independently a substituted or unsubstituted alkyl group having 1 to 20 carbon atoms. Specifically, in Chemical Formula 4, R²¹ to R²⁸ may be each independently an alkyl group having 1 to 6 carbon atoms. More specifically, in Chemical Formula 4, R²¹ to R²⁸ may be methyl groups.

In Chemical Formula 4, d and e may be each independently an integer of 0 to 2, an integer of 0 to 1, or 0.

In Chemical Formula 4, f may be an integer of 0 to 5, an integer of 0 to 4, an integer of 0 to 3, an integer of 0 to 2, or an integer of 1 to 2.

In Chemical Formula 4, R²⁹ may be a substituted or unsubstituted alkoxy group having 1 to 20 carbon atoms. Specifically, in Chemical Formula 4, R²⁹ may be an alkoxy group having 1 to 6 carbon atoms. More specifically, in Chemical Formula 4, R²⁹ may be a methoxy group.

In Chemical Formula 4, the anion (An) may be a halide anion, a cyano anion, a sulfonate anion, an alkoxy anion having 1 to 30 carbon atoms, a substituted or unsubstituted alkyl sulfonate anion having 1 to 30 carbon atoms, a substituted or unsubstituted aromatic sulfonate anion having 6 to 30 carbon atoms, or a substituted or unsubstituted aromatic borate anion having 6 to 30 carbon atoms.

Specifically, in Chemical Formula 4, the anion (An) may be a substituted or unsubstituted alkyl sulfonate anion having 1 to 30 carbon atoms, a substituted or unsubstituted aromatic sulfonate anion having 6 to 30 carbon atoms, or a substituted or unsubstituted aromatic borate anion having 6 to 30 carbon atoms.

More specifically, in Chemical Formula 4, the anion (An) may be an alkyl sulfonate anion having 2 to 15 carbon atoms in which at least one hydrogen is substituted or unsubstituted with fluorine, an alkyl sulfonate anion having 6 to 30 carbon atoms in which at least one carbon is substituted or unsubstituted with —O— or —CO—, a phenyl sulfonate anion substituted or unsubstituted with methyl, or a substituted or unsubstituted tetraaryl borate anion. In one example, in Chemical Formula 4, the anion (An⁻) may be dodecyl sulfonate anion, perfluorobutyl sulfonate anion, phenyl sulfonate anion, methylphenyl sulfonate anion,

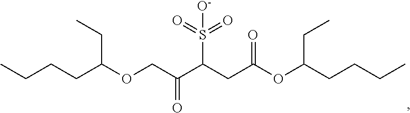 [SMILES: CCCCC(CC)OCC(=O)C(CC(=O)OC(CC)CCCC)S(=O)(=O)[O-]]

or tetraphenylborate anion.

The photopolymer composition of one embodiment may include the photosensitizing dye in an amount of 0.01 to 10 parts by weight based on 100 parts by weight of the polymer matrix. Specifically, the lower limit of the content of the photosensitizing dye may be, for example, 0.02 parts by weight or more, 0.03 parts by weight or more, or 0.05 parts by weight or more, and the upper limit may be, for example, 5 parts by weight or less. When the above range is satisfied, it is advantageous for exhibiting an appropriate polymerization reaction rate and ensuring desired optical recording characteristics.

The coinitiator may include an electron donor, an electron acceptor, or a mixture thereof.

In one example, the photopolymer composition may include an electron donor as a coinitiator. In particular, the photopolymer composition can provide a hologram recording medium having excellent stability over time by using an electron donor exhibiting a specific reaction energy with the above-mentioned photosensitizing dye.

Specifically, the electron donor reacts with a photosensitizing dye excited into a triplet state by light irradiation as shown in the following Reaction Scheme 1, and participates in the photopolymerization initiation reaction.

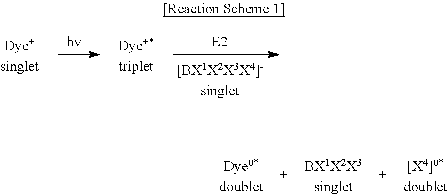

At this time, if an electron donor having a reaction energy of-25 to 0 KJ/mol with a photosensitizing dye excited into a triplet state is used, the reaction does not start even at room temperature to high temperature before light irradiation, showing excellent stability over time, and when light is irradiated, a photoinitiation reaction occurs sensitively, and excellent optical recording characteristics can be exhibited.

More specifically, as the electron donor, the donor in which a reaction energy with a photosensitizing dye excited into triplet state is −25 kJ/mol or more, −20 KJ/mol or more, −15 kJ/mol or more, −14 KJ/mol or more, −13 KJ/mol or more, −12 KJ/mol or more, −11 KJ/mol or more, −10 KJ/mol or more, −9 KJ/mol or more or −8.5 KJ/mol or more, and 0 KJ/mol or less, −3 KJ/mol or less or −5 KJ/mol or less can be used. For the method of measuring the reaction energy, refer to the measurement method described in detail in Test Example described later.

The photopolymer composition of one embodiment may optionally further include an electron acceptor along with an electron donor, as will be described below. The electron acceptor receives electrons during the redox reaction of the photoinitiator system, and when an electron acceptor is contained, the total energy E2 of the photoinitiator system reaction increases toward a negative value. However, as a result of research by the present inventors, even if the total energy of the photoinitiator system reaction changes due to the inclusion of the electron acceptor, excellent stability over time can be ensured only in cases where the reaction energy between the photosensitizing dye and the electron donor is within the above-mentioned range.

The electron donor may include, for example, a borate anion represented by the following Chemical Formula 5.

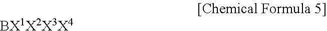

wherein, in Chemical Formula 5, X¹ to X⁴ are each independently an alkyl group having 1 to 20 carbon atoms, an alkenyl group having 2 to 20 carbon atoms, an aryl group having 6 to 30 carbon atoms, an arylalkyl group having 7 to 30 carbon atoms, an alkylaryl group having 7 to 30 carbon atoms, or an allyl group, each of which is substituted or unsubstituted, with the proviso that at least one of X¹ to X⁴ is not an aryl group.

When the alkyl group having 1 to 20 carbon atoms, the alkenyl group having 2 to 20 carbon atoms, the aryl group having 6 to 30 carbon atoms, the arylalkyl group having 7 to 30 carbon atoms, the alkylaryl group having 7 to 30 carbon atoms, or the allyl group is substituted, it may be substituted with at least one selected from the group consisting of a halogen, a vinyl group, a haloalkyl group having 1 to 5 carbon atoms, and an alkoxy group having 1 to 5 carbon atoms.

Specifically, X¹ to X³ may be each independently phenyl, methylphenyl, naphthyl or methylnaphthyl which is substituted or unsubstituted with at least one substituent selected from the group consisting of halogen, vinyl, trifluoromethyl and methoxy groups, and X⁴ may be a straight chain alkyl group having 1 to 12 carbon atoms.

The cation bonded to the borate anion does not absorb light, and may be at least one cation selected from the group consisting of an alkali metal cation, a quaternary ammonium cation, and a nitrogen-containing heterocyclic cation.

The alkali metal cation may be, for example, at least one selected from the group consisting of lithium, sodium, potassium, rubidium, and cesium.

The quaternary ammonium cation may be an ammonium cation in which nitrogen (N) is substituted with four substituents, or a cyclic ammonium cation in which two substituents substituted on nitrogen are connected with each other, or a mixture thereof.

The nitrogen-containing heterocyclic cation may be a heteroaromatic ring cation containing at least one nitrogen. Examples of such heteroaromatic ring cations include pyrrole, pyrazole, imidazole, or pyridine cations, the hydrogen of which may be substituted or unsubstituted.

In one example, when the above-mentioned silicon rhodamine compound is used as a photosensitizing dye, the electron donor may include at least one selected from the group consisting of borate anions represented by the following Chemical Formulas 5-1 and 5-2. The combination of this photosensitizing dye and the borate anion exhibits a reaction energy in the above-mentioned range, ensures excellent stability over time and at the same time exhibits excellent sensitivity, thereby being able to exhibit characteristics excellent in diffraction efficiency, refractive index modulation value, image reproducibility, and angle selectivity, which are all physical properties of the hologram recording medium.

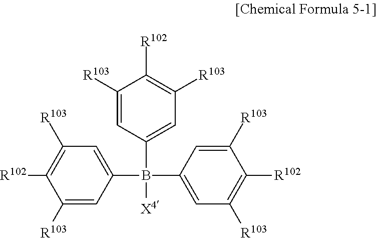

wherein, in Chemical Formula 5-1,
each R¹⁰² is independently methyl or chlorine,
each R¹⁰³ is independently hydrogen, methyl or chlorine, with the proviso that it is chlorine if the adjacent R¹⁰² is methyl, and

X^{4′} is a straight chain alkyl group having 1 to 12 carbon atoms,

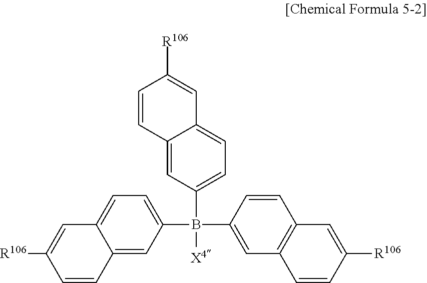

wherein, in Chemical Formula 5-2,
each R¹⁰⁶ is independently hydrogen, methyl or halogen, and
X^{4″} is a straight chain alkyl group having 1 to 12 carbon atoms.

In Chemical Formula 5-2, each R¹⁰⁶ may be independently hydrogen, methyl, or halogen, with the proviso that at least one thereof may be halogen.

In Chemical Formula 5-2, the halogen may be fluorine or chlorine. Among these, chlorine has more excellent heat resistance and can ensure excellent stability over time not only at room temperature but also at high temperature.

In addition, when the above-mentioned silicon rhodamine compound is used as the photosensitizing dye, the cation bonded to the borate anion may include at least one selected from the group consisting of a cation represented by the following Chemical Formula 5-3 (quaternary ammonium cation) and a cation represented by the following Chemical Formula 5-4 (nitrogen-containing heterocyclic cation). The combination of the photosensitizing dye and the borate anion and cation exhibits a reaction energy in the above-mentioned range, ensures excellent stability over time and at the same time exhibits excellent sensitivity, thereby being able to exhibit characteristics excellent in diffraction efficiency, refractive index modulation value, image reproducibility, and angle selectivity, which are all physical properties of the hologram recording medium.

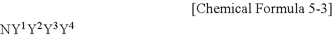

wherein, in Chemical Formula 5-3, two substituents of Y¹ to Y⁴ may or may not be connected with each other to form an aliphatic ring having 4 to 10 carbon atoms, and
Y¹ to Y⁴, which do not form an aliphatic ring, are each independently an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond (e.g., —CH₂CH₂—O—CO—CH₂CH₂CH₃,etc.),
with the proviso that a case where Y¹ to Y⁴ are all methyl groups, or two or more substituents are alkyl groups having 16 or more carbon atoms is excluded.

In Chemical Formula 5-3, if Y¹ to Y⁴ are all methyl groups, or two or more substituents are alkyl groups having 16 or more carbon atoms, the electron donor may not dissolve well in the photopolymer composition, and thus may not exhibit desired optical recording characteristics.

Specifically, among Y¹ to Y⁴, two substituents may be connected with each other to form piperidine or pyrrolidine.

Among the Y¹ to Y⁴, the substituents that do not form an aliphatic ring may each independently be a straight chain alkyl group having 1 to 32 carbon atoms, a phenyl group, a benzyl group, or —CH₂CH₂—O—CO—CH₂CH₂CH₃. More specifically, among the Y¹ to Y⁴, the substituents that do not form an aliphatic ring may be each independently a methyl group, a butyl group, a hexadecyl group, a hentriacontyl group, a phenyl group, or a benzyl group.

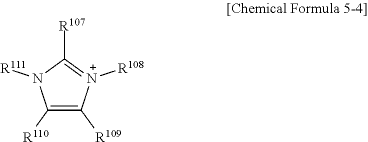

wherein, in Chemical Formula 5-4, R¹⁰⁷, R¹⁰⁹ and R¹¹⁰ are each independently hydrogen, an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond (e.g., —CH₂CH₂—O—CO—CH₂CH₂CH₃, etc.), and
R¹⁰⁸ and R¹¹¹ are each independently an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond (e.g., —CH₂CH₂—O—CO—CH₂CH₂CH₃, etc.).

Specifically, R¹⁰⁷, R¹⁰⁹, and R¹¹⁰ may be each independently hydrogen or an aryl group having 6 to 30 carbon atoms. More specifically, R¹⁰⁷, R¹⁰⁹, and R¹¹⁰ may be each independently hydrogen or a phenyl group.

Specifically, R¹⁰⁸ and R¹¹¹ may be a straight chain alkyl group having 1 to 40 carbon atoms or an arylalkyl group having 6 to 40 carbon atoms. More specifically, R¹⁰⁸ and R¹¹¹ may be a hexadecyl group or a benzyl group.

The cation bonded to the borate anion is a cation represented by Chemical Formulas 5-3 and 5-4, and may include, for example, at least one selected from the group consisting of tetrabutyl ammonium cation, hexadecyl dimethyl benzyl ammonium cation, hentriacontyl dimethyl benzyl ammonium cation, hexadecyl benzyl piperidinium cation, hexadecyl benzyl pyrrolidinium cation, 1-hexadecyl-3-benzylimidazolium cation and 1,3-dihexadecyl-2-phenylimidazolium cation.

However, the cation bonded to the borate anion is not limited to the above-mentioned cations, and even if it shows poor solubility when contained alone, some of the above-mentioned cations may be substituted with other cations known in the related art, as long as it can show adequate solubility when mixed with the above-mentioned cations. By way of non-limiting example, some of the above-mentioned cations may be substituted with 1,2-dicyclohexyl-4,4,5,5-tetramethylbiguanidium, etc.

The photopolymer composition may include the electron donor in the range of 0.05 to 10 parts by weight based on 100 parts by weight of the polymer matrix. Specifically, the lower limit of the content of the electron donor may be, for example, 0.1 part by weight or more, 0.5 part by weight or more, 1 part by weight or more, 1.5 parts by weight or more, or 2 parts by weight or more, and the upper limit thereof may be, for example, 5 parts by weight or less. When the above range is satisfied, it is advantageous for exhibiting an appropriate polymerization reaction rate and ensuring desired optical recording characteristics.

In one example, the photopolymer composition may include an electron acceptor as a coinitiator. The electron acceptor may include, for example, onium salts such as sulfonium salts and iodonium salts; triazine compounds such as tris (trihalomethyl) triazine, substituted bis(trihalomethyl) triazine, etc.; or a mixture thereof.

Specifically, the electron acceptor may include (4-(octyloxy)phenyl) (phenyl) iodonium salt as an iodonium salt, or 2-(4-methoxyphenyl)-4,6-bis (trichloromethyl)-1,3,5-triazine as the triazine compound.

Examples of the electron acceptor include commercially available H-Nu 254 (Spectra Group) or 2-(4-methoxyphenyl)-4,6-bis(trichloromethyl)-1,3,5-triazine (TCI America).

Among these, a triazine compound can be used as the electron acceptor. When a triazine compound is used as an electron acceptor, the stability over time at high temperatures of the hologram recording medium before recording can be further improved.

The photopolymer composition may include the electron acceptor in the range of 0.025 to 2 parts by weight based on 100 parts by weight of the polymer matrix. Specifically, the lower limit of the content of the coinitiator may be, for example, 0.025 parts by weight or more, 0.027 parts by weight or more, 0.030 parts by weight or more, or 0.031 parts by weight or more, and the upper limit thereof may be, for example, 2 parts by weight or less, 1.9 parts by weight or less, 1.7 parts by weight or less, 1.5 parts by weight or less, or 1 part by weight or less. When the above range is satisfied, a hologram recording medium having excellent optical recording characteristics as well as low haze can be provided.

The photoinitiator system may include an additional photoinitiator in order to remove the color of the photosensitizing dye and react all unreacted photoreactive monomers after light irradiation for recording. The photoinitiator may include, for example, imidazole derivatives, bisimidazole derivatives, N-aryl glycine derivatives, organic azide compounds, titanocene, aluminate complex, organic peroxide, N-alkoxy pyridinium salt, thioxanthone derivatives, amine derivatives, diazonium salt, sulfonium salt, iodonium salt, sulfonic acid ester, imide sulfonate, dialkyl-4-hydroxy sulfonium salt, aryl sulfonic acid-p-nitrobenzyl ester, silanol-aluminum complex, (η6-benzene) (η5-cyclopentadienyl) iron (II), benzoin tosylate, 2,5-dinitro benzyl tosylate, N-tosylphthalic acid imide or mixtures thereof, etc. More specifically, the photoinitiator may include 1,3-di (t-butyldioxycarbonyl)benzophenone, 3,3′,4,4″-tetrakis (t-butyldioxycarbonyl)benzophenone, 3-phenyl-5-isoxazolone, 2-mercapto benzimidazole, bis(2,4,5-triphenyl) imidazole, 2,2-dimethoxy-1,2-diphenylethane-1-one (product name: Irgacure 651/manufacturer: BASF), 1-hydroxy-cyclohexyl-phenyl-ketone (product name: Irgacure 184/Manufacturer: BASF), 2-benzyl-2-dimethylamino-1-(4-morpholinophenyl)-butanone-1 (product name: Irgacure 369/Manufacturer: BASF), bis (η5-2,4-cyclopentadiene-1-yl)-bis (2,6-difluoro-3-(1H-pyrrole-1-yl)-phenyl) titanium (product name: Irgacure 784/Manufacturer: BASF), Ebecryl P-115 (manufacturer: SK Entis), Cyracure UVI-6970, Cyracure UVI-6974, Cyracure UVI-6990 (manufacturer: Dow Chemical Co. in USA), Irgacure 264, Irgacure 250 (manufacturer: BASF), CIT-1682 (manufacturer: Nippon Soda) or mixtures thereof, but are not limited thereto.

The photopolymer composition may contain the photoinitiator in the range of 0.05 to 10 parts by weight based on 100 parts by weight of the polymer matrix. Specifically, the siower limit of the content of the photoinitiator may be, for example, 0.1 part by weight or more, 0.5 part by weight or more, 1 part by weight or more, 1.5 parts by weight or more, or 2 parts by weight or more, and the upper limit thereof may be, for example, 5 parts by weight or less. If the above range is satisfied, after optical information is recorded on the photopolymer layer, the reaction of the photoreactive monomer is effectively terminated, and the color of the photosensitizing dye is decolorized, thereby providing a transparent hologram recording medium.

The photopolymer composition of one embodiment may further include additives such as a surfactant or an antifoaming agent.

The photopolymer composition may include a silicone-based surfactant, a fluorine-based surfactant, or a mixture thereof as a surfactant.

As the silicone-based surfactant, for example, BYK-077, BYK-085, BYK-300, BYK-301, BYK-302, BYK-306, BYK-307, BYK-310, BYK-320, BYK-322, BYK-323, BYK-325, BYK-330, BYK-331, BYK-333, BYK-335, BYK-341v344, BYK-345v346, BYK-348, BYK-354, BYK355, BYK-356, BYK-358, BYK-361, BYK-370, BYK-371, BYK-375, BYK-380, BYK-390, BYK-3550 (manufactured by BYK Chemie), and the like can be used. As the fluorine-based surfactant, F-114, F-177, F-410, F-411, F-450, F-493, F-494, F-443, F-444, F-445, F-446, F-470, F-471, F-472SF, F-474, F-475, F-477, F-478, F-479, F-480SF, F-482, F-483, F-484, F-486, F-487, F-172D, MCF-350SF, TF-1025SF, TF-1117SF, TF-1026SF, TF-1128, TF-1127, TF1129, TF-1126, TF-1130, TF-1116SF, TF-1131, TF1132, TF1027SF, TF-1441, TF-1442 (manufactured by DaiNippon Ink & Chemicals), and the like can be used.

If the photopolymer composition of one embodiment includes a surfactant, the surfactant may be contained in an amount of 0.01 parts by weight or more, 0.02 parts by weight or more, 0.03 parts by weight or more, or 0.05 parts by weight or more, and 5 parts by weight or less, or 3 parts by weight or less, based on 100 parts by weight of the polymer matrix. When the above range is satisfied, it can impart excellent adhesion and release properties to the photopolymer layer, and thus preserve excellent optical recording characteristics.

The photopolymer composition of one embodiment may include a silicone-based reactive additive as an antifoaming agent. As the silicone-based reactive additive, for example, commercially available products such as Tego Rad 2500 can be used. The content of the antifoaming agent can be appropriately adjusted at a level that does not impede the function of the hologram recording medium.

The photopolymer composition of one embodiment may further include a solvent.

The solvent may be an organic solvent, and an example thereof may be at least one organic solvent selected from the group consisting of ketones, alcohols, acetates, and ethers, but is not limited thereto. Specific examples of such organic solvents include at least one selected from the group consisting of ketones such as methyl ethyl ketone, methyl isobutyl ketone, acetylacetone, or isobutyl ketone; alcohols such as methanol, ethanol, n-propanol, i-propanol, n-butanol, i-butanol, or t-butanol; acetates such as ethyl acetate, i-propyl acetate, or polyethylene glycol monomethyl ether acetate; and ethers such as tetrahydrofuran or propylene glycol monomethyl ether.

The organic solvent may be added at the time point when respective components contained in the photopolymer composition are mixed, or may be included in the photopolymer composition while respective components are added in a state of being dispersed or mixed in an organic solvent.

The photopolymer composition may include a solvent such that the solid content concentration is 1 to 90% by weight. Specifically, the photopolymer composition may include a solvent such that the solid concentration is 20% by weight or more, 25% by weight or more, or 30% by weight or more, and 50% by weight or less, 45% by weight or less, or 40% by weight or less. Within this range, the photopolymer composition exhibits appropriate flowability and can form a coating layer without defects such as stripes. No defects occur during the drying and curing process and thus, a photopolymer layer exhibiting desired physical properties and surface properties can be formed.

On the other hand, according to another embodiment of the invention, a hologram recording medium including a photopolymer layer formed from the photopolymer composition is provided.

Since the photopolymer composition has been described in detail previously, a detailed description will be omitted here.

The hologram recording medium of another embodiment has excellent refractive index modulation, diffraction efficiency, and driving reliability despite having a photopolymer layer of thin thickness.

The thickness of the photopolymer layer may be, for example, in the range of 5.0 to 40.0 μm. Specifically, the lower limit of the thickness of the photopolymer layer may be, for example, 6 μm or more, 7 μm or more, 8 μm or more, or 9 μm or more. And, the upper limit of the thickness may be, for example, 35 μm or less, 30 μm or less, 29 μm or less, 28 μm or less, 27 μm or less, 26 μm or less, 25 μm or less, 24 μm or less, 23 μm or less, 22 μm or less, 21 μm or less, 20 μm or less, 19 μm or less, or 18 μm or less.

The hologram recording medium according to one embodiment of the invention may further include a substrate on at least one surface of the photopolymer layer. The type of the substrate is not particularly limited, and those known in the related technical field can be used. For example, substrates such as glass, PET (polyethylene terephthalate), TAC (triacetyl cellulose), PC (polycarbonate), or COP (cycloolefin polymer) can be used.

The hologram recording medium according to one embodiment of the invention can have high diffraction efficiency. In one example, the hologram recording medium may have a diffraction efficiency of 80% or more upon recording a notch filter hologram. Wherein, the thickness of the photopolymer layer may be, for example, 5 to 30 μm. Specifically, when recording the notch filter hologram, the diffraction efficiency may be 85% or more, 86% or more, 87% or more, 88% or more, 89% or more, 90% or more, 91% or more, 92% or more, 93% or more, 94% or more, 95% or more, 96% or more, 97% or more, or 98% or more.

In this manner, the hologram recording medium according to one embodiment of the invention can realize excellent diffraction efficiency even if it includes a photopolymer layer of thin thickness. The diffraction efficiency can be measured by the method described in the Test Example described below.

The hologram recording medium according to one embodiment of the invention can exhibit excellent stability over time not only at room temperature but also at high temperature. In one example, the hologram recording medium according to one embodiment of the invention may have a lowest transmittance change of 20% or less which is calculated by the following Equation 1.

$$Δ T ( \% ) = \{ ( \vert {T}_{1} - {T}_{0} \vert ) / {T}_{0} \} \times 100 \qquad [ Equation 1 ]$$

wherein, in Equation 1, T₀ is the lowest transmittance which is measured in the wavelength range of 300 to 1,200 nm using a UV-Vis spectrometer for a sample recording a notch filter hologram after the hologram recording medium before recording is stored in a dark room at a temperature of 20 to 25° C. and a relative humidity of 40 to 50%, and
T₁ is the lowest transmittance which is measured in the same manner as above for a sample recording a notch filter hologram after the hologram recording medium before recording is stored in a dark room at a temperature of 60° C. and a relative humidity of 40 to 50% for 100 hours.

The lowest transmittance change calculated by Equation 1 is an indicator for evaluating the stability over time of the hologram recording medium before recording, especially the stability over time at high temperature (60° C.), and the hologram recording medium of another embodiment can exhibit optical recording characteristics at the originally intended level even if it is left at a high temperature for 100 hours before recording.

Specifically, the hologram recording medium of another embodiment may have the lowest transmittance change (ΔT) calculated by Equation 1 of 20% or less, 19% or less, 18% or less, 17% or less, 16% or less, 15% or less, 14% or less, 13% or less, 12% or less, 11% or less, 10% or less, 9% or less, 8% or less, 7% or less, 6% or less, 5% or less, 4% or less, 3% or less, 2% or less, or 1% or less. The lower limit of the lowest transmittance change (ΔT) calculated by Equation 1 is not particularly limited, and may be 0% or more.

On the other hand, since the hologram recording medium uses a mixture of a component having a low refractive index and a component having a high refractive index to record optical properties, it tends to have opaque characteristics due to their compatibility. However, as the hologram recording medium of another embodiment includes a photopolymer layer that satisfies a specific element ratio or includes a specific content of electron acceptors, it exhibits highly transparent optical properties while having excellent optical recording characteristics.

In one example, the haze of the hologram recording medium may be 2.5% or less. The upper limit of the haze may be, for example, 2.5% or less, 2.4% or less, 2.3% or less, 2.2% or less, 2.1% or less, 2.0% or less, 1.9% or less, 1.8% or less, 1.7% or less, 1.6% or less, 1.5% or less, 1.4% or less, 1.3% or less, 1.2% or less, 1.1% or less, or 1.0% or less. The lower limit of the haze is not particularly limited, and may be 0% or more. The haze may be, for example, the value measured using a haze meter (HM-150, A light source, Murakami) in accordance with JIS K 7136 after preparing a 5 cm×5 cm specimen from a hologram recording medium on which a diffraction grating is recorded.

The hologram recording medium is not limited thereto, but may be a medium on which a reflective hologram or a transmissive hologram is recorded.

On the other hand, according to another embodiment of the present invention, there is provided a method for preparing a hologram recording medium, comprising the steps of: applying a photopolymer composition to form a photopolymer layer, wherein the photopolymer composition comprises a polymer matrix formed by crosslinking a siloxane-based polymer containing a silane functional group and a (meth)acrylic-based polyol, or a precursor thereof; a photoreactive monomer; and a photoinitiator system containing a photosensitizing dye and a coinitiator, and the coinitiator includes an electron donor whose reaction energy with a photosensitizing dye excited into a triplet state is-25 to 0 KJ/mol; and irradiating a coherent laser onto a predetermined region of the photopolymer layer and selectively polymerizing a photoreactive monomer contained in the photopolymer layer to record optical information.

The photopolymer composition has been previously described in detail, and therefore, a detailed description thereof is omitted here.

In the step of forming the photopolymer layer, a photopolymer composition containing the above-mentioned configuration can first be prepared. When preparing the photopolymer composition, for mixing each component, a commonly known mixer, stirrer, mixer or the like can be used without particular restriction. Further, such a mixing process may be performed at a temperature ranging from 0° C. to 100° C., a temperature ranging from 10° C. to 80° C., or a temperature ranging from 20° C. to 60° C.

In the step of forming the photopolymer layer, the prepared photopolymer composition can be applied to form a coating layer formed from the photopolymer composition. The coating layer can be dried at a temperature of 50° C. or more, 55° C. or more, 60° C. or more, 65° C. or more, or 70° C. or more, and 120° C. or less, 110° C. or less, 100° C. or less, or 90° C. or less.

Through this process, a hydrosilylation reaction between the hydroxy group of the (meth)acrylic-based polyol remaining unreacted and the silane functional group of the siloxane-based polymer can be induced, thereby achieving the desired crosslinking density.

In the photopolymer layer prepared through the step of forming the photopolymer layer, a photoreactive monomer and a photoinitiator system, and additives added as necessary may be uniformly dispersed within the crosslinked polymer matrix.

Subsequently, in the step of recording optical information, if a coherent laser is irradiated onto the photopolymer layer, in the area where constructive interference occurs, polymerization of photoreactive monomers occurs to form a photopolymer, and in the area where destructive interference occurs, polymerization of the photoreactive monomer does not occur or is suppressed, so that the photoreactive monomer are present. Further, while the unreacted photoreactive monomer causes refractive index modulation while diffusion occurs toward the photopolymer side where the concentration of photoreactive monomers is lower, and a diffraction grating is produced by the refractive index modulation. Thereby, holograms, i.e. optical information, are recorded on the photopolymer layer having the diffraction grating.

The method for preparing the hologram recording medium according to yet another embodiment of the invention may further include a step of photobleaching by irradiating light onto the entire photopolymer layer on which the optical information is recorded after the step of recording the optical information.

In the photobleaching step, ultraviolet rays are irradiated onto the photopolymer layer on which optical information is recorded to terminate the reaction of the photoreactive monomer remaining in the photopolymer layer, thereby removing the color of the photosensitizing dye. In one example, in the photobleaching step, ultraviolet rays (UVA) in the range of 320 to 400 nm are irradiated to terminate the reaction of the photoreactive monomer and remove the color of the photosensitizing dye.

On the other hand, according to another embodiment of the invention, there is provided an optical element comprising the hologram recording medium.

Specific examples of the optical elements may include smart devices such as mobile devices, parts of wearable displays, vehicle articles (e.g., head up display), holographic fingerprint recognition system, optical lenses, mirrors, deflecting mirrors, filters, diffusing screens, diffraction elements, light guides, waveguides, holographic optical elements having projection screen and/or mask functions, medium of optical memory system and light diffusion plate, optical wavelength multiplexers, reflection type, transmission type color filters, and the like.

An example of an optical element including the hologram recording medium may include a hologram display device. The hologram display device includes a light source unit, an input unit, an optical system, and a display unit.

Specifically, the light source unit is a portion that irradiates a laser beam used for providing, recording, and reproducing three-dimensional image information of an object in the input unit and the display unit.

The input unit is a portion that previously inputs three-dimensional image information of an object to be recorded on the display unit, specifically, a portion in which three-dimensional information of an object such as the intensity and phase of light for each space can be inputted into an electrically addressed liquid crystal SLM, wherein an input beam may be used.

The optical system may include a mirror, a polarizer, a beam splitter, a beam shutter, a lens, and the like. The optical system can be distributed into an input beam for sending a laser beam emitted from the light source unit to the input unit, a recording beam for sending the laser beam to the display unit, a reference beam, an erasing beam, a reading beam, and the like.

The display unit can receive three-dimensional image information of an object from an input unit, record it on a hologram plate comprising an optically addressed SLM, and reproduce the three-dimensional image of the object. At this time, the three-dimensional image information of the object can be recorded via interference of the input beam and the reference beam. The three-dimensional image information of the object recorded on the hologram plate can be reproduced into a three-dimensional image by the diffraction pattern generated by the reading beam. The erasing beam can be used to quickly remove the formed diffraction pattern. On the other hand, the hologram plate can be moved between a position at which a three-dimensional image is inputted and a position at which a three-dimensional image is reproduced.

### Advantageous Effects

The photopolymer composition according to one embodiment of the invention includes an electron donor whose reaction energy with a photosensitizing dye excited into a triplet state is −25 to 0 KJ/mol, thereby being able to provide a hologram recording medium that not only is excellent in optical recording characteristics which are the basic physical properties of hologram recording media, but also exhibits excellent high-temperature stability over time before recording optical information, so that it can exhibit the originally intended optical recording characteristics even when stored at room temperature to high temperature for a long period of time, and can reproduce clear images without problems such as halo.

### BRIEF DESCRIPTION OF THE DRAWINGS

FIG. 1 schematically shows the recording equipment setup for hologram recording. Specifically, FIG. 1 schematically shows the process in which a laser of a predetermined wavelength is radiated from the light source 10, and irradiated onto the PP (hologram recording medium) 80 located on one surface of a mirror 70 via mirrors 20 and 20′, an iris 30, a spatial filter 40, an iris 30′, a collimation lens 50, and PBS (Polarized Beam Splitter) 60.

### DETAILED DESCRIPTION OF THE EMBODIMENTS

Hereinafter, the action and effect of the invention will be described in more detail with reference to specific examples of the invention. However, these examples are presented for illustrative purposes only, and the scope of the invention is not limited thereby in any way.

In the following Preparation Examples, Examples, Comparative Examples, and the like, the content of raw materials, and the like means the content based on solid content, unless otherwise specified.

### Preparation Example 1: Preparation of (Meth)Acrylic-Based Polyol 5

132 g of butyl acrylate, 420 g of ethyl acrylate, and 48 g of hydroxybutyl acrylate were added to a 2 L jacketed reactor, and diluted with 1200 g of ethyl acetate. The reaction temperature was set to 60˜70° C., and the mixture was stirred for about 30 minutes to 1 hour. 0.42 g of n-dodecyl mercaptan(n-DDM) was further added, and stirring was further performed for about 30 minutes. Then, 0.24 g of AIBN as a polymerization initiator was added, polymerization was performed at the reaction temperature for 4 hours or more, and kept until the residual acrylate content became less than 1%. Thereby, a (meth)acrylate-based copolymer (weight average molecular weight of about 300,000, OH equivalent of about 1802 g/equivalent) in which the hydroxy group was located in the branched chain was prepared.

### Preparation Example 2: Preparation of Fluorinated Compound

20.51 g of 2,2′-{oxybis[(1,1,2,2-tetrafluoroethane-2,1-diyl)oxy]}bis(2,2-difluoroethan-1-ol) was added to a 1000 mL flask, and dissolved in 500 g of tetrahydrofuran, to which 4.40 g of sodium hydride (60% dispersion in mineral oil) was carefully added several times while stirring at 0° C. After stirring at 0° C. for 20 minutes, 12.50 mL of 2-methoxyethoxymethyl chloride was slowly added dropwise. When it was confirmed by 1H NMR that all the reactants were consumed, work-up using dichloromethane gave 29 g of a liquid product with a purity of 95% or more in a yield of 98%. The weight average molecular weight of the prepared fluorinated compound was 586, and the refractive index measured with an Abbe refractometer was 1.361.

### Example 1: Preparation of Photopolymer Composition and Hologram Recording Medium

### (1) Preparation of Photopolymer Composition

Trimethylsilyl terminated poly (methylhydrosiloxane) (Sigma-Aldrich, number average molecular weight: about 390, SiH equivalent: about 103 g/equivalent) as a siloxane-based polymer and (meth)acrylic-based polyol prepared in Preparation Example 1 were first mixed. The content of the (meth)acrylic-based polyol was 22.4 g, and the siloxane-based polymer was added so that the SiH/OH molar ratio was 2. In Example 1, 2.6 g of siloxane-based polymer was added.

Then, 52 g of HR 6042 (Miwon Specialty Chemical, refractive index of 1.60) as a photoreactive monomer, 0.2 g of a compound represented by the following Chemical Formula a as a photosensitizing dye, 0.8 g of hexadecyl dimethyl benzyl ammonium tri(m-chloro-p-methylphenyl) butyl borate, and 0.05 g of 2-(4-methoxyphenyl)-4,6-bis (trichloromethyl)-1,3,5-triazine (TCI) as a coinitiator, 0.9 g of Irgacure 369 as a photoinitiator, 23 g of a fluorinated compound prepared in Preparation Example 2 as a plasticizer, and 190 g of methyl isobutyl ketone (MIBK) as a solvent were added, and the mixture was stirred with a paste mixer for about 30 minutes while blocking light. After that, 0.014 g of Karstedt (Pt-based) catalyst was added for matrix crosslinking to prepare a photopolymer composition.

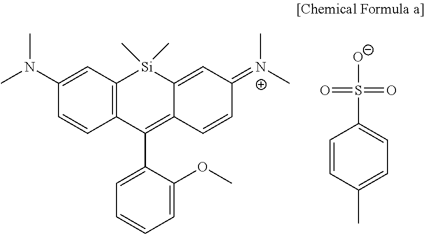

### (2) Preparation of Hologram Recording Media

The photopolymer composition was coated to a predetermined thickness on a 60 μm thick TAC substrate using a Mayer bar, and dried at 80° C. for 10 minutes. The thickness of the photopolymer layer after drying was about 15 μm.

### Examples 2 to 10 and Comparative Examples 1 to 4: Preparation of Photopolymer Composition and Hologram Recording Medium

A photopolymer composition and a hologram recording medium were prepared in the same manner as in Example 1, except that the coinitiator was changed as shown in Table 1 below.

TABLE 1

| | Electron donor | Electron acceptor |
|---|---|---|
| Example 1 | Hexadecyl dimethyl benzyl ammonium | 2-(4-methoxyphenyl)-4,6- |
| | tri(m-chloro-p-methylphenyl)butyl borate | bis(trichloromethyl)-1,3,5- |
| | | triazine |
| Example 2 | Hexadecyl dimethyl benzyl ammonium | — |
| | tri(m-chloro-p-methylphenyl)butyl borate | |
| Example 3 | Hexadecyl dimethyl benzyl ammonium | 2-(4-methoxyphenyl)-4,6- |
| | tri(p-chlorophenyl)butyl borate | bis(trichloromethyl)-1,3,5- |
| | | triazine |
| Example 4 | Hexadecyl dimethyl benzyl ammonium | — |
| | tri(p-chlorophenyl)butyl borate | |
| Example 5 | Tetrabutyl ammonium tri(6-chloro-2- | 2-(4-methoxyphenyl)-4,6- |
| | naphthyl)butyl borate | bis(trichloromethyl)-1,3,5- |
| | | triazine |
| Example 6 | Tetrabutyl ammonium tri(6-chloro-2- | — |
| | naphthyl)butyl borate | |
| Example 7 | Tetrabutyl ammonium tri(m-chloro-p- | 2-(4-methoxyphenyl)-4,6- |
| | methylphenyl)butyl borate | bis(trichloromethyl)-1,3,5- |
| | | triazine |
| Example 8 | Tetrabutyl ammonium tri(m-chloro-p- | — |
| | methylphenyl)butyl borate | |
| Example 9 | Tetrabutyl ammonium tri(2- | — |
| | naphthyl)butyl borate | |
| Example 10 | Hexadecyl benzyl pyrrolidinium tri(p- | |
| | chlorophenyl)butyl borate | |
| Comparative | WPBG-300 (1,2-dicyclohexyl- | 2-(4-methoxyphenyl)-4,6- |
| Example 1 | 4,4,5,5-tetramethylbiguanidium | bis(trichloromethyl)-1,3,5- |
| | tri(phenyl)butyl borate) | triazine |
| Comparative | WPBG-300 | — |
| Example 2 | | |
| Comparative | Tetrabutyl ammonium tri(p- | — |
| Example 3 | fluorophenyl)butyl borate | |
| Comparative | Tetrabutyl ammonium tri(o- | — |
| Example 4 | methylphenyl)hexyl borate | |

### Test Example 1: Analysis of Hologram Recording Medium

### (1) Element Ratio

The surface element ratios of a sample before recording and a sample after recording were analyzed by the method described below.

Specifically, the sample to be analyzed was fixed onto a copper foil with a carbon tape, which was placed on the sample holder and fixed using a clip. Then, data were acquired using an X-ray photoelectron spectrometer (ESCA, model name: K-Alpha+, Thermo Fisher Scientific Inc.) according to the K-Alpha+standard operating method (SOP-0524-Ok), and the element ratio (atomic %) of the sample surface was analyzed using Avantage software (version 5.980).

The system specifications of the ESCA device used are as follows.
Base chamber pressure: 1.0×10⁻⁹ mbar
X-ray source: monochromatic Al Ka (1486.6 eV)
X-ray spot size: 400 μm
Mode: CAE (Constant Analyzer Energy) mode
Charge compensation: Flood gun (FG03: 100 μA, 0.5 V)

Qualitative analysis was performed on the surface of the sample to be analyzed in the as-received state using an initial survey scan under the following conditions. Depending on the qualitative analysis results, quantitative analysis was performed through narrow scan (snap) for each element. The element ratios at three locations were confirmed for each sample, and the peak background smart method was applied for quantitative analysis. The binding energy correction of the core level spectrum was based on C 1s (284.8 eV).

### <Survey Scan Conditions>

Scan section binding energy: −5˜1350 eV
Step size: 1 eV
Per Point dwell time: 20 ms
Periods: 2
Pass energy: 200 eV

### <Narrow Scan Conditions>

Scan section binding energy: about 20 e V
Step size: ˜0.16 eV
Per Point dwell time: 1 sec
Periods: 10˜30
Pass energy: 150 eV

### <Etching Conditions>

Source: Ar ion
Energy: 6 ke V
Cluster size: 75
Rater size: 1.6×1.0 mm²
Mode: GCIB

All the photopolymer compositions prepared in Examples and Comparative Examples contained a polymer matrix, a photoreactive monomer and a fluorinated compound, which accounted for the largest proportion of their solid contents, in an amount of 25 g, 52 g, and 23 g, respectively, so that the weight ratio of the polymer matrix:photoreactive monomer:fluorinated compound was all 25:52:23.

As a result, it was shown that the element ratios of all the samples prepared in Examples and Comparative Examples were 62.1 atomic % for carbon, 0.9 atomic % for nitrogen, 21.0 atomic % for oxygen, 6.2 atomic % for fluorine, and 9.8 atomic % for silicon.

In addition, as a result of measuring the element ratios on the surface of the sample before recording and the sample after recording, the element ratios on the surface of the sample before and after recording were measured to be the same.

### (2) Calculation of Reaction Energy

In order to calculate the reaction energy E2 in Reaction Scheme 1 below, the lowest excited singlet energy (S1) of the borate anion (BX¹X²X³X⁴) as an electron donor and the lowest excited triplet energy (T1) of the photosensitizing dye (Dye) were determined using Gaussian 16, which is a quantum chemical calculation program manufactured by Gaussian. S1 and T1 were calculated using density functional theory (DFT) for the optimized structure using B3LYP as the functional and 6-31G* as the basis function.

Since the photosensitizing dye undergoes an electron reduction reaction, T1 is written as a negative value, and since the electron donor undergoes an electron oxidation reaction, S1 is written as a positive value, and the total reaction energy E2 is calculated by adding these.

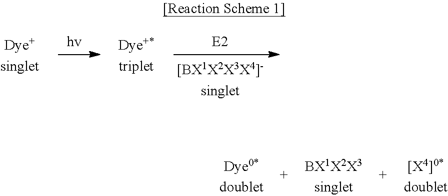

TABLE 2

| | T1 of | | S1 of | Reaction | |
|---|---|---|---|---|---|
| | photosensitizing | | electron | energy | |
| | dye | Types of electron donors | donor | (E2) | |
| Example 1 | −465.4 kJ/mol | Hexadecyl dimethyl benzyl | +454.9 kJ/mol | −10.5 | kJ/mol |
| | | ammonium tri(m-chloro-p- | | | |
| | | methylphenyl)butyl borate | | | |
| Example 2 | | Hexadecyl dimethyl benzyl | +454.9 kJ/mol | −10.5 | kJ/mol |
| | | ammonium tri(m-chloro-p- | | | |
| | | methylphenyl)butyl borate | | | |
| Example 3 | | Hexadecyl dimethyl benzyl | +456.9 kJ/mol | −8.5 | kJ/mol |
| | | ammonium tri(p- | | | |
| | | chlorophenyl)butyl borate | | | |
| Example 4 | | Hexadecyl dimethyl benzyl | +456.9 kJ/mol | −8.5 | kJ/mol |
| | | ammonium tri(p- | | | |
| | | chlorophenyl)butyl borate | | | |
| Example 5 | | Tetrabutyl ammonium tri(6- | +456.9 kJ/mol | −8.5 | kJ/mol |
| | | chloro-2-naphthyl)butyl borate | | | |
| Example 6 | | Tetrabutyl ammonium tri(6- | +456.9 kJ/mol | −8.5 | kJ/mol |
| | | chloro-2-naphthyl)butyl borate | | | |
| Example 7 | | Tetrabutyl ammonium tri(m- | +454.9 kJ/mol | −10.5 | kJ/mol |
| | | chloro-p-methylphenyl)butyl | | | |
| | | borate | | | |
| Example 8 | | Tetrabutyl ammonium tri(m- | +454.9 kJ/mol | −10.5 | kJ/mol |
| | | chloro-p-methylphenyl)butyl | | | |
| | | borate | | | |
| Example 9 | | Tetrabutyl ammonium tri(2- | +443.8 kJ/mol | −21.6 | kJ/mol |
| | | naphthyl)butyl borate | | | |
| Example 10 | | Hexadecyl benzyl pyrrolidinium | +456.9 kJ/mol | −8.5 | kJ/mol |
| | | tri(p-chlorophenyl)butyl borate | | | |
| Comparative | | WPBG-300 | +435.3 kJ/mol | −30.1 | kJ/mol |
| Example 1 | | | | | |
| Comparative | | WPBG-300 | +435.3 kJ/mol | −30.1 | kJ/mol |
| Example 2 | | | | | |
| Comparative | | Tetrabutyl ammonium tri(p- | +438.9 kJ/mol | −26.5 | kJ/mol |
| Example 3 | | fluorophenyl)butyl borate | | | |
| Comparative | | Tetrabutyl ammonium tri(o- | +399.1 kJ/mol | −66.3 | kJ/mol |
| Example 4 | | methylphenyl)hexyl borate | | | |

### Test Example 2: Evaluation of Performance of Hologram Recording Medium

### (1) Thermal Stability (ΔT)

Thermal stability was evaluated on the basis of the degree of the lowest transmittance change (ΔT) before and after exposure to high temperatures. Specifically, after a diffraction grating was recorded on a sample before recording that was not exposed to high temperatures and a sample before recording that was exposed to high temperatures, the thermal stability was evaluated on the basis of the degree of the lowest transmittance change, and the degree of the lowest transmittance change was determined using the following Equation 1.

$$Δ T ( \% ) = \{ ( \vert {T}_{1} - {T}_{0} \vert ) / {T}_{0} \} \times 100 \qquad [ Equation 1 ]$$

wherein, in Equation 1, T₀ is the lowest transmittance which was measured in the wavelength range of 300 to 1,200 nm using a UV-Vis spectrometer for a notch filter hologram recording sample after the hologram recording medium before recording is stored in a dark room under a constant temperature (20 to 25° C.) and a constant humidity (40 to 50% relative humidity), and T1 is the lowest transmittance which was measured in the same manner as above for a notch filter hologram recording sample after the sample before recording is stored in a dark room at a temperature of 60° C. and a relative humidity of 40 to 50% for 100 hours.

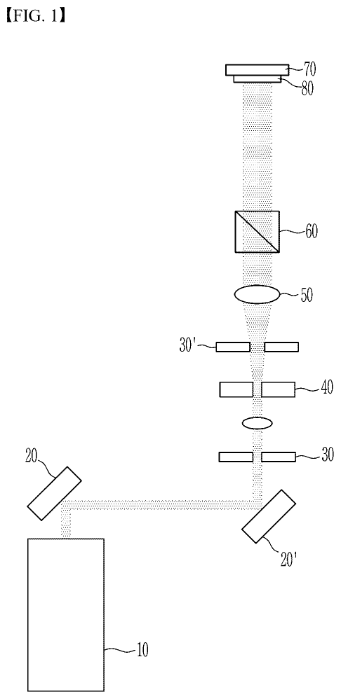

The notch filter hologram was recorded using the same setup as shown in FIG. 1. Specifically, when the prepared photopolymer layer was laminated on a mirror and then irradiated with a laser, a notch filter hologram with periodic refractive index modulation in the thickness direction could be recorded through interference between incident light (L) and light reflected from the mirror (L′). In this example, the notch filter hologram was recorded with an incident angle of 0° (degree). Notch filter and Bragg reflector are optical devices that reflect only light of a specific wavelength, and have a structure in which two layers with different refractive indices are stacked periodically and repeatedly at a constant thickness.

### (2) Diffraction Efficiency (DE)

Diffraction efficiency (η) was determined through the following Equation 2 for the sample in which the notch filter hologram was recorded in the same manner as mentioned above.

$$η ( \% ) = \{ {P}_{D} / ( {P}_{D} + {P}_{T} ) \} \times 100 \qquad [ Equation 2 ]$$

wherein, in Equation 2, η is the diffraction efficiency, PD is the output amount (mW/cm²) of the diffracted beam of the sample after recording, and P_{T} is the output amount (mW/cm²) of the transmitted beam of the sample after recording.

### (3) Whether or not Halo Generates

It was confirmed whether a halo was observed on the hologram recording medium. Specifically, the sample in which the notch filter hologram was recorded in the above-described manner was irradiated with the incident light (L) that was irradiated during hologram recording, and holographic optical information was reproduced. Then, the reproduced holographic optical information was observed with the naked eye to determine whether a halo, which is a cloudy-looking area, was observed around the reproduced holographic optical information.

It is marked as ‘OK’ if no halo is observed on the holographic optical information recording medium, and as ‘NG’ if a halo was observed.

TABLE 3

| | Reaction | | Thermal | Diffraction | Whether or |
|---|---|---|---|---|---|
| | energy | | stability | efficiency | not halo |
| | (E2) | | (ΔT, %) | (DE, %) | generates |
| Example 1 | −10.5 | kJ/mol | 3.2 | 97.0 | OK |
| Example 2 | −10.5 | kJ/mol | 5.8 | 89.2 | OK |
| Example 3 | −8.5 | kJ/mol | 0.8 | 98.0 | OK |
| Example 4 | −8.5 | kJ/mol | 1.2 | 92.7 | OK |
| Example 5 | −8.5 | kJ/mol | 2.1 | 91.2 | OK |
| Example 6 | −8.5 | kJ/mol | 4.2 | 87.8 | OK |
| Example 7 | −10.5 | kJ/mol | 7.8 | 90.2 | OK |
| Example 8 | −10.5 | kJ/mol | 11.2 | 88.5 | OK |
| Example 9 | −21.6 | kJ/mol | 15.3 | 87.9 | OK |
| Example 10 | −8.5 | kJ/mol | 2.2 | 91.5 | OK |
| Comparative | −30.1 | kJ/mol | 78 | 92.1 | NG |
| Example 1 | | | | | |
| Comparative | −30.1 | kJ/mol | 92.8 | 89.2 | NG |
| Example 2 | | | | | |
| Comparative | −26.5 | kJ/mol | 94 | 93.2 | NG |
| Example 3 | | | | | |
| Comparative | −66.3 | kJ/mol | 100 | 96.4 | NG |
| Example 4 | | | | | |

Referring to Table 3, it is confirmed that the photopolymer composition according to one embodiment of the invention includes an electron donor whose reaction energy with a photosensitizing dye excited into a triplet state is-25 to 0 KJ/mol, thereby being able to provide a hologram recording medium that not only is excellent in optical recording characteristics such as diffraction efficiency, but also exhibits excellent stability over time at high temperatures before recording. In addition, it is confirmed that the hologram recording media prepared in Examples can reproduce clear images without problems such as halo.

1. A photopolymer composition comprising:
a polymer matrix formed by crosslinking a siloxane-based polymer containing a silane functional group and a (meth)acrylic-based polyol, or a precursor thereof; a photoreactive monomer; and a photoinitiator system containing a photosensitizing dye and a coinitiator,
wherein the coinitiator includes an electron donor whose reaction energy with a photosensitizing dye excited into a triplet state is −25 to 0 KJ/mol.

2. The photopolymer composition according to claim 1, wherein the siloxane-based polymer comprises a repeating unit represented by the following Chemical Formula 1 and a terminal end group represented by the following Chemical Formula 2: 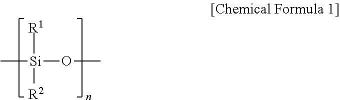
wherein, in the Chemical Formula 1,
a plurality of R¹ and R² are the same or different from each other, and are each independently hydrogen, halogen, or an alkyl group having 1 to 10 carbon atoms, and
n is an integer of 1 to 10,000, 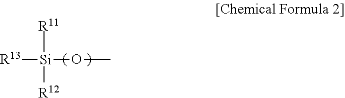
wherein, in the Chemical Formula 2,
a plurality of R¹¹ to R¹³ are the same or different from each other, and are each independently hydrogen, halogen, or an alkyl group having 1 to 10 carbon atoms, and
at least one of R¹, R² and R¹¹ to R¹³ of at least one repeating unit selected among the repeating units represented by Chemical Formula 1 and any one terminal end group selected among the terminal end groups represented by Chemical Formula 2 is hydrogen.

3. The photopolymer composition according to claim 1, wherein the (meth)acrylic-based polyol is a polymer in which a hydroxy group is bonded to a main chain or side chain of the (meth)acrylate-based polymer.

4. The photopolymer composition according to claim 1, wherein a molar ratio of the silane functional group of the siloxane-based polymer to a hydroxy group of the (meth)acrylic-based polyol is 1.5 to 4.

5. The photopolymer composition according to claim 1, wherein the photoreactive monomer comprises at least one monofunctional monomer selected from the group consisting of benzyl (meth)acrylate, benzyl 2-phenylacrylate, phenoxybenzyl (meth)acrylate, phenol (ethylene oxide) (meth)acrylate, phenol (ethylene oxide)₂ (meth)acrylate, O-phenylphenol (ethylene oxide) (meth)acrylate, phenylthioethyl (meth)acrylate and biphenylmethyl (meth)acrylate; at least one polyfunctional monomer selected from the group consisting of bisphenol A (ethylene oxide)_{2˜10} di(meth)acrylate, bisphenol A epoxy di(meth)acrylate, bisfluorene di(meth)acrylate, modified bisphenol fluorene di(meth)acrylate, tris(2-hydroxyethyl) isocyanurate tri(meth)acrylate, phenol novolac epoxy (meth)acrylate and cresol novolac epoxy (meth)acrylate; or a mixture of two or more thereof.

6. The photopolymer composition according to claim 1, wherein the photoreactive monomer is contained in an amount of 50 to 300 parts by weight based on 100 parts by weight of the polymer matrix.

7. The photopolymer composition according to claim 1, further comprising a fluorinated compound.

8. The photopolymer composition according to claim 7, wherein the composition comprises 17 to 38% by weight of the polymer matrix, 36 to 58% by weight of the photoreactive monomer, and 17 to 38% by weight of the fluorinated compound, based on a total weight of the polymer matrix, the photoreactive monomer, and the fluorinated compound.

9. The photopolymer composition according to claim 1, wherein the photosensitizing dye comprises a silicon rhodamine compound represented by the following Chemical Formula 4: 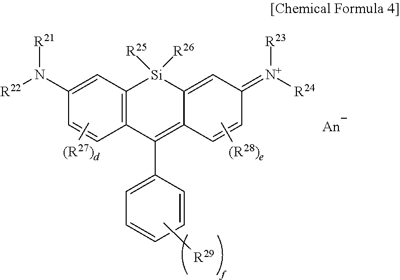
wherein, in the Chemical Formula 4,
R²¹ to R²⁹ are each independently hydrogen, a substituted or unsubstituted alkyl group having 1 to 20 carbon atoms, a substituted or unsubstituted alkoxy group having 1 to 20 carbon atoms, a substituted or unsubstituted aryl group having 6 to 30 carbon atoms, or a substituted or unsubstituted aryloxy group having 6 to 30 carbon atoms,
d and e are each independently an integer of 0 to 3,
f is an integer of 0 to 5, and
An⁻ is an anion.

10. The photopolymer composition according to claim 1, wherein the electron donor comprises a borate anion represented by the following Chemical Formula 5: 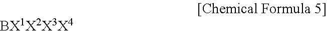
wherein, in the Chemical Formula 5,
X¹ to X⁴ are each independently an alkyl group having 1 to 20 carbon atoms, an alkenyl group having 2 to 20 carbon atoms, an aryl group having 6 to 30 carbon atoms, an arylalkyl group having 7 to 30 carbon atoms, an alkylaryl group having 7 to 30 carbon atoms, or an allyl group, each of which is substituted or unsubstituted, with the proviso that at least one of X¹ to X⁴ is not an aryl group.

11. The photopolymer composition according to claim 1, wherein the electron donor comprises at least one borate anion selected from the group consisting of borate anions represented by the following Chemical Formulas 5-1 and 5-2: 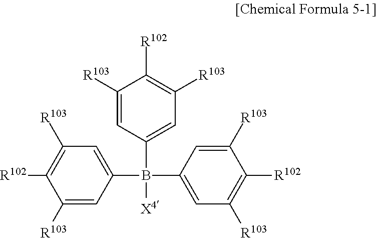
wherein, in the Chemical Formula 5-1,
each R¹⁰² is independently methyl or chlorine,
each R¹⁰³ is independently hydrogen, methyl or chlorine, with the proviso that it is chlorine if the adjacent R¹⁰² is methyl, and
X^{4′} is a straight chain alkyl group having 1 to 12 carbon atoms, 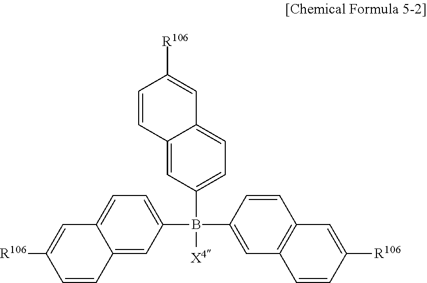
wherein, in the Chemical Formula 5-2,
each R¹⁰⁶ is independently hydrogen, methyl or halogen, and
X^{4″} is a straight chain alkyl group having 1 to 12 carbon atoms.

12. The photopolymer composition according to claim 1, wherein
the electron donor comprises at least one selected from the group consisting of a cation represented by the following Chemical Formula 5-3 and a cation represented by the following Chemical Formula 5-4: 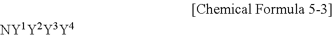
wherein, in the Chemical Formula 5-3,
two of Y¹ to Y⁴ are optionally er may not be-connected with each other to form an aliphatic ring having 4 to 10 carbon atoms, and
Y¹ to Y⁴, which do not form an aliphatic ring, are each independently an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond,
with the proviso that a case where Y¹ to Y⁴ are all methyl groups, or at least two of Y¹ to Y⁴ are alkyl groups having 16 or more carbon atoms, is excluded, 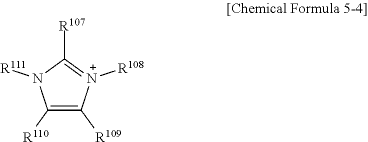
wherein, in the Chemical Formula 5-4,
R¹⁰⁷, R¹⁰⁹ and R¹¹⁰ are each independently hydrogen, an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond, and
R¹⁰⁸ and R¹¹¹ are each independently an alkyl group having 1 to 40 carbon atoms, an aryl group having 6 to 30 carbon atoms, an arylalkyl group having 6 to 40 carbon atoms, or an alkyl group having 2 to 40 carbon atoms connected through an ester bond.

13. The photopolymer composition according to claim 1, wherein the coinitiator comprises an electron acceptor.

14. The photopolymer composition according to claim 13, wherein the electron acceptor comprises an onium salt, a triazine compound or a mixture thereof.

15. The photopolymer composition according to claim 13, wherein the electron acceptor is contained in an amount of 0.025 to 2 parts by weight based on 100 parts by weight of the polymer matrix.

16. A hologram recording medium comprising a photopolymer layer formed from the photopolymer composition according to claim 1.

17. The hologram recording medium according to claim 16, wherein the photopolymer layer further comprises a fluorinated compound, wherein an element ratio of carbon is 50 to 70 atomic %, an element ratio of nitrogen is 0.01 to 2 atomic %, an element ratio of oxygen is 15 to 30 atomic %, an element ratio of fluorine is 3 to 12 atomic %, and an element ration of silicon is 3 to 15 atomic %, based on a total amount of carbon, nitrogen, oxygen, fluorine and silicon atoms on a surface thereof as confirmed by photoelectron spectroscopy.

18. The hologram recording medium according to claim 16, wherein when recording a notch filter hologram, a diffraction efficiency is at least 80%.

19. A method for preparing a hologram recording medium, comprising the steps of: applying the photopolymer composition according to claim 1 to form a photopolymer layer; and irradiating a coherent laser onto a predetermined region of the photopolymer layer and selectively polymerizing a photoreactive monomer contained in the photopolymer layer to record optical information.

20. An optical element comprising a hologram recording medium comprising a photopolymer layer formed from the photopolymer composition according to claim 1.
